(19) United States
(12) Patent Application Publication
(10) Pub. No.: US 2009/0280037 A1
(43) Pub. Date: Nov. 12, 2009

(54) Exhaust gas purification apparatus for an internal combustion engine

(75) Inventors: Taro Aoyama, Susono-shi (JP); Yasuaki Nakano, Sunto-gun (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 12/308,100

(22) PCT Filed: Jun. 11, 2007
(86) PCT No.: PCT/JP2007/062187

§ 371 Date: Dec. 8, 2008

(30) Foreign Application Priority Data
Jun. 9, 2006 (JP) 2006-160857

(51) Int. Cl. G05D 7/00

(52) U.S. Cl. 422/111

(57) ABSTRACT

There is provided a technique which can reduce the NOx stored in an NOx storage reduction catalyst. In case where concentrated reduction is carried out so as to add a reducing agent to the NOx storage reduction catalyst in a concentrated manner when a shift has been made from a state in which reduction of the NOx stored in said NOx storage reduction catalyst is unable to be performed in spite of a request for reduction of the NOx into a state in which reduction of the NOx is able to be performed, the level of concentration upon addition of the reducing agent is changed based on the amount of the NOx stored in the NOx storage reduction catalyst and the temperature of the NOx storage reduction catalyst.

### TECHNICAL FIELD

The present invention relates to an exhaust gas purification apparatus for an internal combustion engine.

### BACKGROUND ART

When the NOx stored in an NOx storage reduction catalyst is to be reduced, so-called rich spike control is carried out that serves to enrich the air fuel ratio of an exhaust gas flowing into the NOx storage reduction catalyst in a spike-like manner (for a short time) at a relatively short cycle. However, when the temperature of the NOx storage reduction catalyst is low for example, a reducing agent does not react with the NOx storage reduction catalyst, so the NOx contained therein can hardly be reduced even if a reduction request therefor is made. During that time, NOx is discharged from an internal combustion engine, so a lot of NOx is stored into the NOx storage reduction catalyst.

Here, in the NOx storage reduction catalyst, the purification rate of NOx decreases as the amount of NOx storage increases. Thus, if NOx is swiftly reduced when a shift is made from a state in which NOx is unable to be reduced into a state in which NOx is able to be reduced, it is possible to improve the purification rate of NOx in a swift manner.

In addition, there has been known a technique in which the reduction of NOx is performed with the amount of addition of a reducing agent being increased more than that in an ordinary state, for a predetermined period of time after a shift is made from a state where rich spike control is unable to be performed in spite of a request made for the reduction of NOx stored in an NOx storage reduction catalyst into a state where rich spike control is able to be performed (see, for example, a first patent document (Japanese patent application laid-open No. 2004-360486), a second patent document (Japanese patent application laid-open No. 2005-127287), a third patent document (Japanese patent application laid-open No. 2005-61340), a fourth patent document (Japanese patent application laid-open No. 2003-269142), and a fifth patent document (Japanese patent application laid-open No. 2003-27925)).

However, even if the amount of addition of the reducing agent is simply increased, the reduction efficiency of NOx does not always become maximum. For example, the NOx reduction efficiency is changed depending on the temperature of the NOx storage reduction catalyst, so by changing the amount of addition of the reducing agent in accordance with the temperature of the NOx storage reduction catalyst, the NOx reduction efficiency can be made higher in accordance with the temperature thereof at that time.

### DISCLOSURE OF THE INVENTION

The present invention has been made in view of the above-mentioned problems, and has for its object to provide a technique in an exhaust gas purification apparatus for an internal combustion engine which is capable of reducing the NOx stored in an NOx storage reduction catalyst in a swift manner upon shifting into a state where the NOx stored in the NOx storage reduction catalyst is able to be reduced.

In order to achieve the above object, an exhaust gas purification apparatus for an internal combustion engine according to the present invention adopts the following technique. That is, the exhaust gas purification apparatus for an internal combustion engine according to the present invention includes:

a reducing agent addition device that adds a reducing agent to an exhaust gas discharged from the internal combustion engine; and

an NOx storage reduction catalyst that can store NOx, with the NOx concluded therein being able to be reduced by the reducing agent added by said reducing agent addition device;

wherein in case where concentrated reduction is carried out so as to add the reducing agent to said NOx storage reduction catalyst in a concentrated manner when a shift has been made from a state in which reduction of the NOx stored in said NOx storage reduction catalyst is unable to be performed in spite of a request for reduction of the NOx into a state in which reduction of the NOx is able to be performed, the level of concentration upon addition of said reducing agent during said concentrated reduction is changed based on the amount of NOx stored in said NOx storage reduction catalyst and the temperature of said NOx storage reduction catalyst.

Here, the term “the level of concentration” means the extent by which the amount of the reducing agent to be supplied is increased from that in ordinary reduction by changing the interval or amount of addition of the reducing agent or the like. In addition, the higher the level of concentration, the addition of the reducing agent is performed in the more concentrated manner. That is, the higher the level of concentration, the shorter the addition interval of the reducing agent becomes or the more the amount of addition of the reducing agent becomes. The concentrated reduction is performed for a period of time from shifting into said state in which the NOx is able to be reduced until the request for reduction of the NOx for example. Here, note that the addition of the reducing agent performed after the concentrated reduction is referred to as ordinary addition, and the amount of addition of the reducing agent at that time is referred to as an ordinary amount of addition.

In addition, the state “there is a request for reduction of the NOx stored in said NOx storage reduction catalyst” shows that the amount of NOx stored in the NOx storage reduction catalyst exceeds a threshold, for example, and hence the purification rate of the NOx might be decreased. Also, “the state in which the NOx is unable to be reduced” is a state in which even if the reducing agent is supplied, the NOx is hardly able to be reduced due, for example, to the low temperature of the NOx storage reduction catalyst. This may be a state in which the NOx storage reduction catalyst is equal to or less than an activation temperature thereof. In this case, the time when the temperature of the NOx storage reduction catalyst has risen to a temperature in which reduction of the NOx is able to be performed is “the time when a shift has been made into a state in which reduction of the NOx is able to be performed”. In other cases, too, a shift can be made into a state in which reduction of the NOx is unable to be performed, depending on the operating state of the internal combustion engine.

Further, at the time “when a shift has been made into a state in which the NOx is able to be reduced”, the reduction of the NOx has not been performed until that time, so a more amount of NOx has been stored in the NOx storage reduction catalyst in comparison with ordinary reducing agent addition time. In contrast to this, by performing concentrated reduction at the time “when a shift has been made into a state in which the NOx is able to be reduced”, the reduction of the NOx can be swiftly carried out, so it is possible to recover the NOx storage capacity of the NOx storage reduction catalyst in a swift manner.

Here, the amount of the reducing agent actually involved in the reduction of the NOx with respect to the amount of the reducing agent added to the NOx storage reduction catalyst changes in accordance with the temperature of the NOx storage reduction catalyst. That is, by changing the amount of addition or the addition interval of the reducing agent based on the temperature of the NOx storage reduction catalyst, it is possible to add an amount of the reducing agent corresponding to a reduction efficiency of the NOx. In other words, said level of concentration may be changed based on the reduction efficiency of the NOx.

Moreover, the more the increasing amount of the NOx stored in the NOx storage reduction catalyst becomes, the more swiftly the amount of NOx storage may be decreased, whereby the purification rate of the NOx can be improved. That is, by changing the amount of addition or the addition interval of the reducing agent based on the amount of the NOx stored in the NOx storage reduction catalyst, it is possible to add an amount of the reducing agent corresponding to the amount of NOx storage. In other words, said level of concentration may be changed based on the purification rate of the NOx.

In a preferred form of the present invention, when the reducing agent is added to said NOx storage reduction catalyst, said level of concentration may be lowered in accordance with increasing departure of the temperature of said NOx storage reduction catalyst from a temperature range in which reduction efficiency is high.

Here, lowering the level of concentration means increasing the interval at which the reducing agent is added or decreasing the amount of addition of the reducing agent.

The temperature range in which reduction efficiency is high is a temperature range in which the reduction of the NOx is efficiently performed, and includes a temperature at which the reduction of the NOx is performed in the most efficient manner. That is, in the temperature range in which reduction efficiency is high, the more amount of NOx can be reduced by increasing the amount of addition or the frequency of addition of the reducing agent more than that in other temperature range.

On the other hand, the NOx reduction efficiency decreases as the temperature of the NOx storage reduction catalyst departs from the temperature range in which reduction efficiency is high. Thus, if a large amount of reducing agent is added, it will be consumed wastefully. In contrast to this, by decreasing the amount of addition or the frequency of addition of the reducing agent in accordance with the lowering temperature of the NOx storage reduction catalyst, it is possible to add an amount of reducing agent corresponding to the reduction efficiency.

Here, note that the meaning of “said level of concentration is lowered in accordance with increasing departure of the temperature of said NOx storage reduction catalyst from a temperature range in which reduction efficiency is high” includes that the more apart from the temperature range in which reduction efficiency is high, the lower the level of concentration is made gradually or stepwise.

In another preferred form of the present invention, when the reducing agent is added to said NOx storage reduction catalyst, said level of concentration may be raised in accordance with the increasing amount of the NOx stored in said NOx storage reduction catalyst.

Here, raising the level of concentration means shortening the interval at which the reducing agent is added or increasing the amount of addition of the reducing agent.

The more the amount of the NOx stored in the NOx storage reduction catalyst, the lower the purification rate of the NOx becomes, so it is desirable to reduce the NOx in a swifter manner. In addition, by adding a more amount of reducing agent or increasing the frequency of addition of the reducing agent in accordance with the increasing amount of the stored NOx, the NOx stored in the NOx storage reduction catalyst can be swiftly reduced.

Here, note that the meaning of “said level of concentration is raised in accordance with the increasing amount of the NOx stored in said NOx storage reduction catalyst” includes that the more the amount of the NOx stored in the NOx storage reduction catalyst, the level of concentration is raised gradually or stepwise.

As described above, according to an exhaust gas purification apparatus for an internal combustion engine of the present invention, the NOx stored in an NOx storage reduction catalyst can be reduced in a swift manner upon shifting into a state where the NOx stored in the NOx storage reduction catalyst is able to be reduced.

### BRIEF DESCRIPTION OF THE DRAWINGS

FIG. 1 shows the schematic construction of an internal combustion engine with an intake system and an exhaust system to which an exhaust gas purification apparatus for an internal combustion engine according to an embodiment of the present invention is applied.

FIGS. 2(A) and 2(B) are timing diagrams showing mutually different relations between an NOx storage amount counter and addition timing of an reducing agent, respectively.

FIG. 3 is a view showing the relation among the ratio between the NOx storage rate (speed) of an NOx catalyst and the inflow rate (speed) of NOx flowing into the NOx catalyst, the bed temperature of the NOx catalyst and the coefficient of an addition interval.

FIG. 4 is a flow chart showing a processing flow for concentrated reduction control in this embodiment.

### BEST MODE FOR CARRYING OUT THE INVENTION

Hereinafter, a specific embodiment of an exhaust gas purification apparatus for an internal combustion engine according to the present invention will be described while referring to the accompanying drawings.

### Embodiment 1

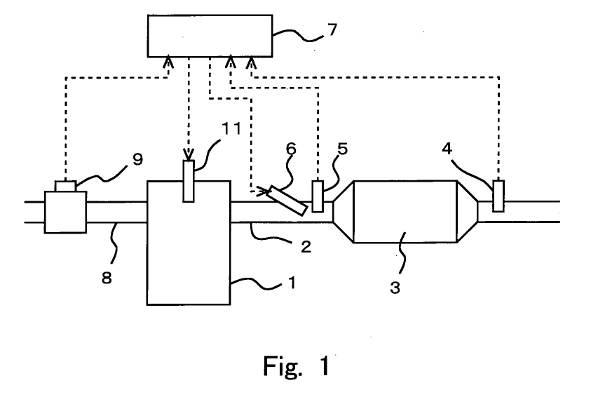

FIG. 1 shows the schematic construction of an internal combustion engine with an intake system and an exhaust system to which an exhaust gas purification apparatus for an internal combustion engine according to an embodiment of the present invention is applied. The internal combustion engine, illustrated in FIG. 1 and generally designated at reference numeral 1, is a water-cooled four-cycle diesel engine.

The internal combustion engine 1 is provided with fuel injection valves 11 (only one being illustrated in FIG. 1 for the sake of simplicity and convenience of description) for supplying fuel to each cylinder. In addition, connected with the internal combustion engine 1 is an exhaust passage 2 which leads at its one or upstream end to a combustion chamber of each engine cylinder, and at its other or downstream end to the atmosphere.

An NOx storage reduction catalyst 3 (hereinafter simply referred to as an NOx catalyst 3) is arranged on the exhaust passage 2. When the oxygen concentration of an exhaust gas flowing into the NOx catalyst 3 is high, the NOx catalyst 3 stores NOx in the exhaust gas, whereas when the oxygen concentration of the incoming exhaust gas is low with the presence of a reducing agent, the NOx catalyst 3 has a function to reduce the NOx stored therein.

In addition, an air fuel ratio sensor 4 for outputting a signal corresponding to an air fuel ratio of the exhaust gas flowing into the exhaust passage 2 is installed on the exhaust passage 2 at a downstream side of the NOx catalyst 3. Also, an exhaust temperature sensor 5 for outputting a signal corresponding to the temperature of the exhaust gas flowing through the exhaust passage 2 is installed on the exhaust passage 2 at a location upstream of the NOx catalyst 3. The temperature of the NOx catalyst 3 is detected by the exhaust gas temperature sensor 5.

A reducing agent addition valve 6 for adding a reducing agent in the form of fuel (light oil) to the exhaust gas passing through the exhaust passage 2 is installed on the exhaust passage 2 at a location upstream of the NOx catalyst 3. The reducing agent addition valve 6 is driven to open by means of a signal from an ECU 7 to be described later for injecting fuel into the exhaust gas. The fuel injected from the reducing agent addition valve 6 into the exhaust passage 2 serves to enrich the air fuel ratio of the exhaust gas flowing from an upstream side of the exhaust passage 2, and when the NOx is reduced, so-called rich spike control is carried out that serves to enrich the air fuel ratio of the exhaust gas flowing into the NOx catalyst 3 in a spike-like manner (for a short time) at a short period or cycle. Here, note that the reducing agent addition valve 6 in this embodiment corresponds to a reducing agent addition device in the present invention.

Further, connected with the internal combustion engine 1 is an intake passage 8 which leads to the combustion chamber of each engine cylinder. An airflow meter 21 for outputting a signal corresponding to an amount of intake air flowing through the intake passage 8 is installed on the intake passage 8.

The ECU 7 in the form of an electronic control unit for controlling the internal combustion engine 1 is provided in conjunction with the internal combustion engine 1 as constructed in the above-described manner. This ECU 7 serves to control the operating state of the internal combustion engine 1 in accordance with the operating condition (or requirement) of the internal combustion engine 1 and the driver's requirement.

The air fuel ratio sensor 4, the exhaust gas temperature sensor 5 and the air flow meter 9 are connected to the ECU 7 through electrical wiring, so that output signals of these sensors and meter are input to the ECU 7. On the other hand, the fuel injection valves 11 and the reducing agent addition valve 6 are connected to the ECU 7 through electrical wiring, so that the fuel injection valves 11 and the reducing agent addition valve 6 are controlled by the ECU 7.

In addition, in this embodiment, when a shift is made from a state in which the rich spike control of the NOx stored in the NOx catalyst 3 is unable to be performed into a state in which the rich spike control thereof is able to be performed, concentrated reduction is carried out in which the NOx is reduced with the addition interval of the reducing agent being shortened more than an ordinary one.

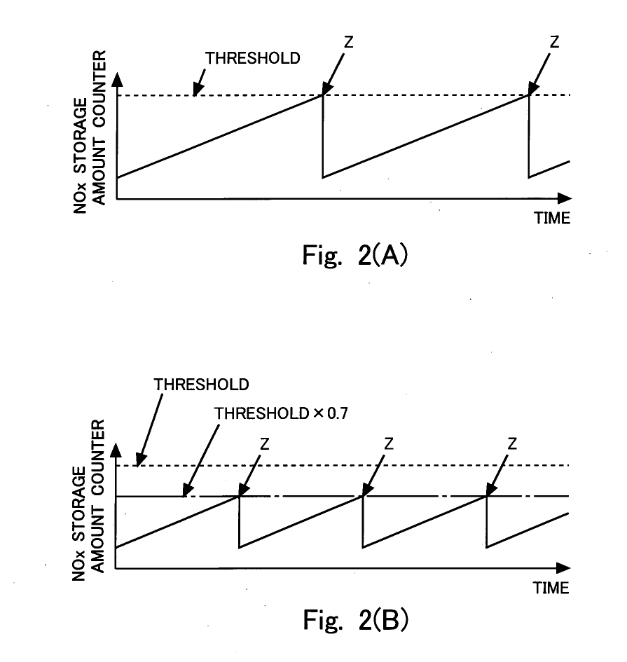

Here, FIGS. 2(A) and 2(B) are timing diagrams that show mutually different relations between an NOx storage amount counter and addition timing of the reducing agent, respectively. FIG. 2(A) shows when ordinary reducing agent addition is carried out, and FIG. 2(B) shows when concentrated reduction is carried out.

The NOx storage amount counter indicates the amount of NOx stored in the NOx catalyst 3 after execution of reduction processing of the NOx. The NOx reduction processing is executed when the NOx storage amount counter reaches a threshold (i.e., shown by broken lines in FIGS. 2(A) and 2(B)). In other words, when the amount of NOx stored after the last NOx reduction processing being counted reaches the threshold, the reduction of the stored NOx is performed, and the NOx reduction processing is executed at a point indicated by Z in FIGS. 2(A) and 2(B). However, in case where there is a lot of amount of NOx stored in the NOx catalyst 3 such as immediately after a shift has been made from the state where the NOx reduction processing is unable to be performed into the state where it is able to be performed, the NOx can not be fully reduced even if the NOx reduction processing is performed one time, and a not-so-small amount of NOx still remains unreduced.

On the other hand, in case of executing the concentrated reduction (in case of FIG. 2(B)), the reduction processing of the NOx is carried out when the value of the NOx storage amount counter is smaller than that at the time of ordinary reduction (in case of FIG. 2(A)). Here, note that FIG. 2(B) shows the case in which the addition interval coefficient is set to 0.7. This addition interval coefficient is used to change the execution timing of the NOx reduction processing by being multiplying with the above-mentioned threshold. That is, when the addition interval coefficient is larger than 1, the execution interval of the NOx reduction processing is longer in the concentrated reduction than in the ordinary reduction, whereas when the addition interval coefficient is smaller than 1, the execution interval of the NOx reduction processing is shorter in the concentrated reduction than in the ordinary reduction.

In other words, in case of FIG. 2(B), the addition interval coefficient is set to 0.7, so when the NOx storage amount counter reaches a value that is obtained by multiplying the threshold of FIG. 2(A) by 0.7 (i.e., shown by an alternate long and short dash line in FIG. 2(B)), the NOx reduction processing is executed. That is, the time required until the threshold is reached becomes shorter in the concentrated reduction than in the ordinary reduction, so the interval to add the reducing agent becomes shorter. As a result, the NOx reduction processing is frequently executed, and hence, even when the amount of NOx stored in the NOx catalyst 3 is large, the amount of NOx storage can be swiftly decreased.

Here, note that a target air fuel ratio in the NOx catalyst 3 when the reducing agent is supplied thereto is the same at the time of ordinary addition or reduction and at the time of concentrated reduction. In addition, the amount of addition of the reducing agent is also the same as that in the ordinary reduction. That is, the amount of addition of the reducing agent per rich spike is the same in either case.

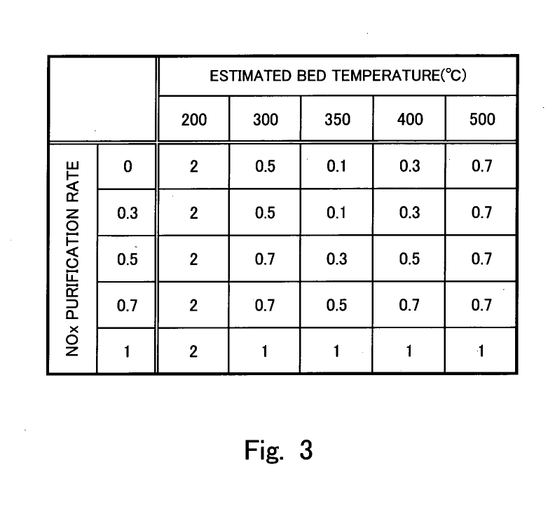

Further, FIG. 3 is a view that shows the relation among the NOx purification rate, the bed temperature of the NOx catalyst 3, and the addition interval coefficient.

The NOx purification rate here is a value that is obtained by dividing the storage speed of NOx in the NOx catalyst 3 by the inflow speed of the NOx flowing into the NOx catalyst 3. The storage speed of NOx is the amount of storage of NOx per unit time in the NOx catalyst 3. In addition, the inflow speed of the NOx is the amount of the NOx flowing into the NOx catalyst 3 per unit time.

The storage speed of NOx in the NOx catalyst 3 correlates to the amount of NOx stored in the NOx catalyst 3, so the relation between the storage speed of NOx and the amount of NOx stored in the NOx catalyst 3 is obtained and mapped beforehand by experiments or the like. Also, the inflow speed of the NOx flowing into the NOx catalyst 3 relates to the number of revolutions per minute of the engine and the engine load, so the relation among the inflow speed of the NOx, the number of revolutions per minute of the engine and the engine load is obtained and mapped beforehand by experiments or the like. The NOx purification rate can be obtained based on the maps thus obtained.

The reducing agent is generally added in a specified amount when the amount of NOx stored in the NOx catalyst 3 exceeds a preset threshold. In contrast to this, in case where concentrated reduction is performed, the addition of the reducing agent is carried out before the amount of NOx stored in the NOx catalyst 3 reaches the threshold. At this time, the timing of the fuel addition is decided by using the addition interval coefficient. This addition interval coefficient is used to calculate a new threshold by being multiplying with the above-mentioned threshold. In other words, if the addition interval coefficient is decreased to a value less than 1, rich spike control will be performed before the NOx stored in the NOx catalyst 3 reaches the threshold. On the contrary, if the addition interval coefficient is increased to a value more than 1, rich spike control will be performed after the NOx stored in the NOx catalyst 3 exceeds the threshold.

In addition, the smaller the ratio between the storage speed of NOx in the NOx catalyst 3 and the inflow speed of the NOx flowing into the NOx catalyst 3, the lower the purification rate of the NOx becomes, and hence the more the amount of the reducing agent to be supplied becomes. As a result, the purification rate of the NOx can be further improved. Thus, the lower the above-mentioned NOx purification rate, the smaller the addition interval coefficient is made so as to accordingly shorten the addition interval of the reducing agent. That is, the more the amount of the NOx stored in the NOx storage reduction catalyst, the higher the level of concentration at the time of the concentrated reduction is made.

However, it may be considered that the addition interval coefficient is made constant depending upon the temperature of the NOx catalyst 3. Specifically, in case where the NOx catalyst 3 becomes active but the temperature of the NOx catalyst 3 is too low so that the reducing agent might adhere to the NOx catalyst 3 (i.e., HC poisoning), the amount of addition of the reducing agent is decreased to a value less than that in the ordinary reduction. That is, the addition interval coefficient is made larger than 1. This corresponds to the case in which the bed temperature of the NOx catalyst 3 is 200 degrees C. in FIG. 3, and at this time, the addition interval coefficient is set to 2. With this, the HC poisoning of the NOx catalyst 3 can be suppressed.

On the other hand, in case where the reduction efficiency of the NOx is high but the temperature of the NOx catalyst 3 is too high so that the thermal degradation of the NOx catalyst 3 might be facilitated, the addition interval coefficient is decided in such a manner that the thermal degradation of the NOx catalyst 3 can be suppressed. This corresponds to the case in which the bed temperature of the NOx catalyst 3 is 500 degrees C. in FIG. 3, and at this time, the addition interval coefficient is set to 0.7.

In addition, in the NOx catalyst 3 according to this embodiment, the reduction efficiency becomes the highest when the bed temperature is in the vicinity of 350 degrees C. That is, a more amount of NOx can be reduced by lowering the addition interval coefficient in the vicinity of this temperature to increase the frequency of supply of the reducing agent.

Moreover, the more apart from the vicinity of 350 degrees C. the bed temperature of the NOx catalyst 3 becomes, i.e., the higher or lower from this temperature, the lower the reduction efficiency of the NOx becomes. Thus, the more apart from a region of high reduction efficiency, the addition interval coefficient is increased so as to make longer the supply interval of the reducing agent. That is, the level of concentration during the concentrated reduction is decreased in accordance with increasing departure from the temperature range where the reduction efficiency is high.

Here, note that when the ratio of the storage speed of NOx in the NOx catalyst 3 and the inflow speed of the NOx flowing into the NOx catalyst 3 is 1, the purification rate of the NOx becomes high, so the concentrated reduction is not required. Accordingly, in this case, the addition interval coefficient is adjusted to 1. That is, the reducing agent is added at an ordinary interval. However, when the temperature of the NOx catalyst 3 is low, there is a fear of the above-mentioned HC poisoning, and hence the addition interval coefficient is adjusted to 2.

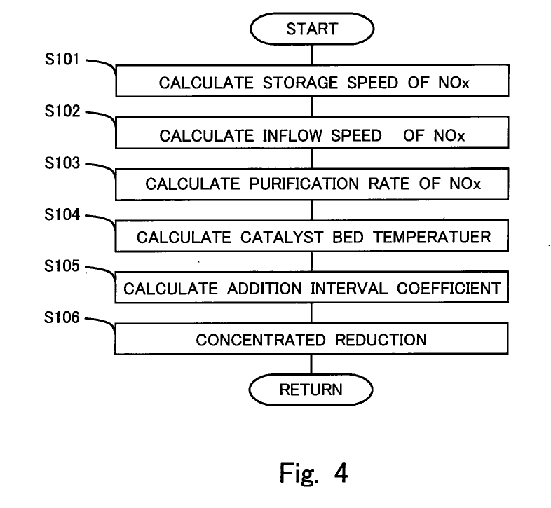

Next, reference will be made to a processing flow of the concentrated reduction control in this embodiment. FIG. 4 is a flow chart that shows the processing flow of the concentrated reduction control in this embodiment. This routine is executed for a predetermined time after a shift is made from a state where NOx was unable to be reduced at a time such as after the engine was cold started, etc., into a state where NOx is able to be reduced.

In step S101, the storage speed of NOx is calculated. The storage speed of NOx in the NOx catalyst 3 correlates to the amount of NOx collected in the NOx catalyst 3, so the relation between the storage speed of NOx and the amount of NOx collected is obtained and mapped beforehand by experiments or the like. Thus, the storage speed of NOx can be obtained by assigning the amount of collection of the NOx to this map. The amount of the NOx collected by the NOx catalyst 3 can be obtained, for example, from a differential pressure between an upstream side and a downstream side of the NOx catalyst 3 that is measured by a sensor installed at an appropriate location.

In step S102, the inflow speed of the NOx is calculated. This inflow speed of NOx changes in accordance with the number of revolutions per minute of the engine and the engine load (i.e., the amount of injected fuel or the degree of accelerator opening), so the relation among the inflow speed of NOx, the number of revolutions per minute of the engine, and the engine load is obtained and mapped beforehand by experiments or the like. Thus, the inflow speed of NOx can be obtained by assigning the number of revolutions per minute of the engine and the engine load to this map.

In step S103, the NOx purification rate in the NOx catalyst 3 is calculated. The NOx purification rate is obtained by dividing the storage speed of NOx by the inflow speed of NOx.

In step S104, it is determined whether the bed temperature of the NOx catalyst 3 is estimated. The bed temperature of the NOx catalyst 3 can be obtained from the exhaust gas temperature sensor 5.

In step S105, the addition interval coefficient is calculated. The addition interval coefficient can be obtained by assigning the estimated bed temperature and the NOx purification rate of the NOx catalyst 3 to a map shown in FIG. 3. This map is obtained and stored in the ECU 7 beforehand by experiments or the like.

In step S106, the concentrated reduction is carried out according to the addition interval coefficient thus calculated in step S105.

In this manner, the addition interval coefficient can be obtained in accordance with the bed temperature of the NOx catalyst 3 and the NOx purification rate, and efficient addition of the reducing agent can be made by adding the reducing agent based on the addition interval coefficient thus obtained. In other words, when the reduction efficiency of NOx is high due to the high bed temperature of the NOx catalyst 3, the amount of NOx storage can be swiftly decreased by making the execution interval of the NOx reduction processing shorter. As a result, the purification rate of NOx can be improved in a swift manner.

Further, in case where there is fear that the bed temperature of the NOx catalyst 3 might become too high, the overheating of the NOx catalyst 3 can be suppressed by making the addition interval coefficient large. Furthermore, when the bed temperature of the NOx catalyst 3 is low, too, the HC poisoning of the NOx catalyst 3 can be suppressed by making the addition interval coefficient large. With these measures, fuel mileage can also be improved.

In addition, the more the amount of NOx storage in the NOx catalyst 3, the addition interval coefficient is decreased, so the amount of NOx storage can be reduced in a swift manner.

1. An exhaust gas purification apparatus for an internal combustion engine comprising:
a reducing agent addition device that adds a reducing agent to an exhaust gas discharged from said internal combustion engine; and
an NOx storage reduction catalyst that can store NOx, with the NOx concluded therein being able to be reduced by the reducing agent added by said reducing agent addition device;
wherein in case where concentrated reduction is carried out so as to add the reducing agent to said NOx storage reduction catalyst in a concentrated manner when a shift has been made from a state in which reduction of the NOx stored in said NOx storage reduction catalyst is unable to be performed in spite of a request for reduction of the NOx into a state in which reduction of the NOx is able to be performed, the level of concentration upon addition of said reducing agent during said concentrated reduction is changed based on the amount of the NOx stored in said NOx storage reduction catalyst and the temperature of said NOx storage reduction catalyst.

2. The exhaust gas purification apparatus for an internal combustion engine as set forth in claim 1, wherein
when said reducing agent is added to said NOx storage reduction catalyst, said level of concentration is lowered in accordance with increasing departure of the temperature of said NOx storage reduction catalyst from a temperature range in which reduction efficiency is high.

3. The exhaust gas purification apparatus for an internal combustion engine as set forth in claim 1, wherein
when said reducing agent is added to said NOx storage reduction catalyst, said level of concentration is raised in accordance with the increasing amount of the NOx stored in said NOx storage reduction catalyst.

4. The exhaust gas purification apparatus for an internal combustion engine as set forth in claim 2, wherein
when said reducing agent is added to said NOx storage reduction catalyst, said level of concentration is raised in accordance with the increasing amount of the NOx stored in said NOx storage reduction catalyst.
